(19) United States
(12) Patent Application Publication
(10) Pub. No.: US 2004/0117983 A1
(43) Pub. Date: Jun. 24, 2004

(54) Method for the operation of a component placement unit, component placement unit for carrying out said method and feed device for said component placement unit

(76) Inventors: Erwin Beck, Roehrmoos (DE); Ralf Bloemer, Neukirchen-Vluyn (DE)

Correspondence Address: HARNESS, DICKEY & PIERCE, P.L.C., P.O.BOX 8910, RESTON, VA, 20195, US

(21) Appl. No.: 10/333,856

(22) PCT Filed: Aug. 2, 2001
(86) PCT No.: PCT/DE01/02934

(30) Foreign Application Priority Data
Aug. 10, 2000 (DE) 100 39 201.6

(51) Int. Cl. B23Q 15/00; B23P 21/00; B25J 19/00

(52) U.S. Cl. 29/832; 29/739; 29/742; 29/721; 294/64.1; 901/47

(57) ABSTRACT

The invention relates to a method for the operation of a component placement unit, a component placement unit for carrying out said method and a feed device for said component placement unit, permitting an optimised flexible operation of component placement units, whereby the main transport direction (HT) of the transport runs (130, 140) is reversed and component supports (110, 120, 120-R) are transported in the opposite direction (GT).

Method for the operation of a component placement unit, component placement unit for carrying out said method and transfer device for said component placement unit

The invention relates to a method for the operation of a component placement unit for the placement of electrical components on component supports, a component placement unit for carrying out said method and a transfer device for such a component placement unit.

Conventionally, a component placement unit for the placement of components on component supports, such as for example electrical printed circuit boards, has a plurality of processing locations, such as for example screen printers, automatic component placement machines, soldering furnaces or test equipment, and also a transport run running substantially in a straight line, by means of which the processing locations are connected to one another. Depending on the number of electrical components to be placed on each component support, the transport run allows component supports to be processed by the component placement unit in parallel in a number of processing locations simultaneously or, in the case of a relatively large number of electrical components, processed in series. One result of this is that subassemblies which require a great variety of different components can be provided with all their components without requiring any modification work at the processing locations. Another result is that a large number of less complex component supports can be simultaneously provided with components in parallel by a number of automatic component placement machines and subsequently taken for example into a common soldering furnace.

In the case of conventional component placement units, the component supports are delivered at an area at the beginning of the component placement units and introduced into the latter by a feeding device. By means of the transport runs, the component supports are taken over the processing locations and thereby processed. After completion of the processing, it is necessary to pick up the completely processed component supports at the end of the component placement unit. If it is intended, for example, for component supports to be processed on both sides, it is necessary to transport the component supports back to the beginning of the component placement unit by means of an additional external transport run. For this purpose, however, both an additional transfer station, by which the completely processed component supports can be transferred to the external transport run, and an external transport run are necessary. Both require additional space and increase the processing time, since the component supports first have to run through the entire unit before they can be transported back to the beginning of the component placement unit. With such an arrangement, however, the various processing locations of a component placement unit cannot be optimally utilized.

The invention is based on the object of providing a method for the operation of a component placement unit, a component placement unit for carrying out said method and a transfer device for said component placement unit, which ensures optimum processing with regard to the required processing time and the achievable throughput.

The object is achieved by the invention according to the independent claims. Preferred refinements of the invention are claimed in the dependent claims.

The invention provides a method for the operation of a component placement unit for placing electrical components on component supports, the unit having a plurality of processing locations. The processing locations are connected to one another by means of one or more transport runs, by which the component supports are transported in a main transporting direction. In the case of the method according to the invention, component supports are transported over the transport run to the processing locations in the main transporting direction. The component supports and/or the electrical components are processed at the processing locations. Furthermore, at least for a certain time, the main transporting direction of one or more of the transport runs is reversed, whereby the component supports are transported from one processing location to another processing location in the opposite transporting direction.

The invention makes it possible, for example, to transport component supports which have already run through the last processing location of the component placement unit back to any desired other processing location of the component placement unit by means of the transport run connected to the processing location. This is meaningful, for example, when placing different components or the same components on either side of component supports. Furthermore, it may also be necessary to repeat a processing step, such as for example running repeatedly through a specific processing unit, such as for example a furnace. In addition, it may be meaningful with regard to optimizing the times for running through the automatic component placement machines to transport the component supports which have not yet been provided with all their components between the automatic component placement machines by means of variable transport operations in the main transporting direction and in the opposite transporting direction, in order to achieve optimum utilization of the component placement locations of the automatic component placement machines.

According to one aspect of the invention, it may be necessary before transporting component supports in the opposite transporting direction to check whether transporting in the opposite transporting direction on one or more transport runs is meaningful from aspects of optimization. For this purpose, it may be checked for example whether all the component placement locations of the automatic component placement machines have just been supplied with a component support which is to be provided with components, so that no supplying transport operations to the automatic component placement machines are required. In this state, the transport runs present at the automatic component placement machines can be used without any problem for transporting component supports back in the opposite transporting direction.

According to a further aspect of the invention, it may also be necessary to buffer-store at the processing locations or between the processing locations the component supports which are to be transported in the opposite transporting direction. For this purpose, buffer stores which can receive a differing number of component supports may be provided. When a selectable number of component supports is reached in the buffer store, transporting in the opposite transporting direction may be carried out on one or more transport runs of the component placement unit. As a result, the transport runs of the component placement unit are taken up only for a short time by the transport operations in the opposite transporting direction.

According to the invention, a component placement unit for carrying out the method according to the invention is also provided. Such a component placement unit is provided with a plurality of processing locations and also one or more transport runs. The main transporting direction of the transport runs of the component placement unit can be selectively reversed for transport operations from one processing location to another processing location.

The transport run and/or the processing locations may be coupled to a control unit. From this control unit, the levels of utilization of the transport runs can be checked on the basis of determined information concerning the state of the transport runs. This allows the control unit to make a reliable statement on whether a reversal of the main transporting direction and transporting of component supports in the opposite transporting direction is possible without impairment of the processing of the component supports carried out by the processing locations.

According to a further aspect of the invention, a transfer device for a component placement unit is provided, which device can be used in the case of a component placement unit with at least two transport runs and a plurality of processing locations connected by means of the transport runs for the processing of component supports and/or electrical components. The transfer device has at least two transport subruns, which are vertically and/or horizontally displaceable and are at least temporarily in line with the transport runs. The main transporting direction of the transport subruns of the transfer device is in this case selectively reversible. A switch or transfer of component supports between the transport runs is possible. For instance, in the case of two or more transport runs of the component placement unit it is possible by selective use of transport runs that are respectively free for the transporting operation in the opposite transporting direction to be optimized in such a way that the processing in the main transporting direction is not delayed.

The invention is explained in more detail on the basis of preferred embodiments with reference to the drawing, in which:

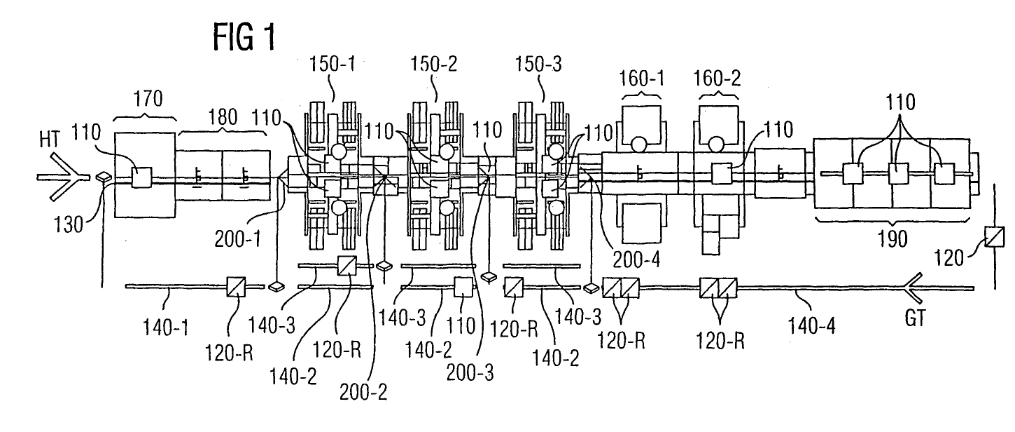

FIG. 1 shows a schematic view of a component placement unit with a number of processing locations and a number of transport runs according to a preferred embodiment of the invention,

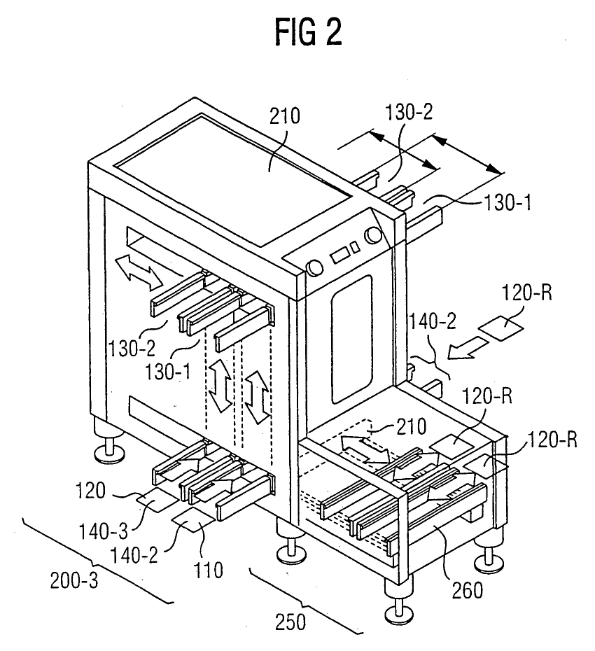

FIG. 2 shows a perspective schematic view of a transfer device according to a preferred embodiment of the invention,

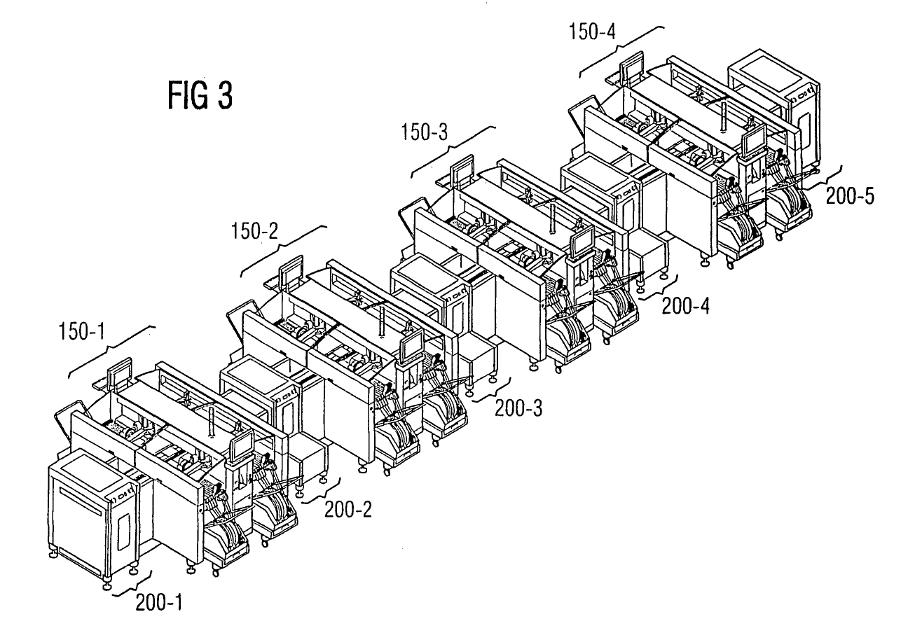

FIG. 3 shows a schematic perspective view of a portion of a component placement unit according to a preferred embodiment of the invention, having automatic component placement machines and transfer devices, and

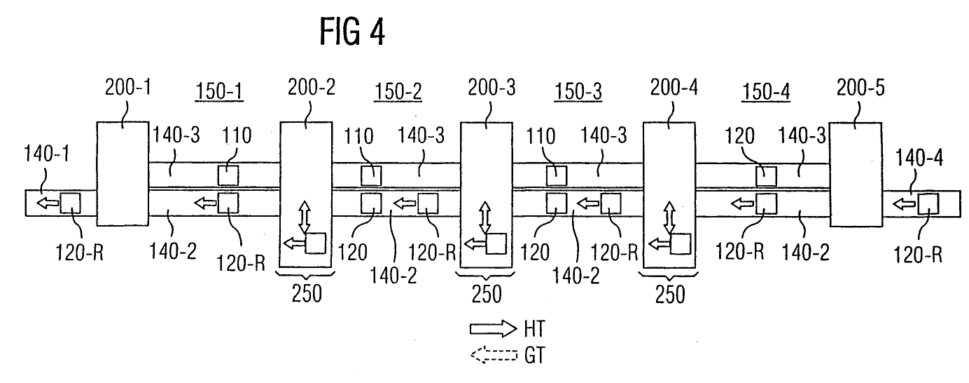

FIG. 4 shows a schematic functional view of the portion of the component placement unit according to FIG. 3.

As can be seen from FIG. 1, a component placement unit according to a preferred embodiment of the invention has a plurality of processing locations 150-1, 150-2, 150-3, 160-1, 160-2, 180, 170 and 190. The various processing locations may be, for example, a feeding unit for component supports 170, a screen printing unit 180 for printing on the component supports with soldering paste, automatic component placement machines 150-1, 150-2, 150-3, special automatic component placement machines 160-1, 160-2, or a soldering furnace 190. However, other processing locations are also possible, such as for example test equipment.

The processing locations cross with a plurality of transport runs 130 and 140, i.e. are connected to one another by means of the transport runs 130. The transport runs 130 and 140 are respectively subdivided into a number of portions, which are adapted for example to the individual processing locations. Component supports 110 to be provided with components are shown in FIG. 1 at different locations of the component placement unit. For example, a component support 110 is arranged in the feeding unit 170. Two component supports 110 are respectively arranged in each of the automatic component placement machines 150-1, 150-2, 150-3.

The main transporting direction HT of the component placement unit is indicated by the arrow HT and runs from the feeding unit 170 via the screen printers 180 to the automatic component placement machines 150-1, 150-2, 150-3 and from the latter via the special automatic component placement machines 160-1, 160-2 to the soldering furnace 190. At the last automatic component placement machine 150-3, seen in the main transporting direction HT, two component supports 110 are shown evidently in a pick-up position, from which they are fed by means of the transport run 130 to the special automatic component placement machines 160-1 and 160-2. Two further component supports 110 are represented at the entry portion of the last automatic component placement machine 150-3 in the main transporting direction HT. After the component supports 110 located in the pick-up position have been removed from the automatic component placement machine 150-3 by means of the transport run, these further supports are transported into the component placement positions of the automatic component placement machine 150-3.

It can likewise be seen from FIG. 1 that a component support 110 is located in the special automatic component placement machine 160-2 and three component supports 110 are located in the soldering furnace 190. FIG. 1 depicts in this respect the occupancy of the individual processing locations and transport runs 130, 140 at an arbitrary point in time of the operation of the component placement unit according to the preferred embodiment of the invention. The transport run 140, shown underneath the processing locations, is subdivided into a number of portions 140-1, 140-2, 140-3 and 140-4. The portion 140-1 runs in the area of the feeding unit 170 and the screen printer 180. The portions 140-2 and 140-3 form two parallel transport runs in the area of the automatic component placement machines 150-1, 150-2 and 150-3. The portion 140-4 runs in the area of the special automatic component placement machines 160-1 and 160-2 and the soldering furnace 190. In the portion 140-4, the transport run 140 is occupied by a number of component supports 120-R provided with some of or all their components.

Arranged on the portions 140-1, 140-2, 140-3 and 140-4 are component supports 120-R to be transported in the opposite transporting direction GT, which according to the invention are transported in the opposite transporting direction. They may have already been provided with all their components or some of their components or else have already been partly soldered.

The portion 140-4 of the transport run 140 that is arranged in the area of the soldering furnace 190 and the special automatic component placement machines 160 is capable of buffer-storing a plurality of component supports 120-R which have been provided with all their components or some of their components and/or partly or completely soldered, which are to be transported in the opposite transporting direction GT of the component placement unit. The transport runs 140-2 and 140-3, shown underneath the automatic component placement machines 150-1, 150-2 and 150-3 and assigned to the latter, are highly frequented, for example in parallel operation of the automatic component placement machines 150-1, 150-2 and 150-3 by means of the transfer devices 200-1, 200-2, 200-3 and 200-4, between the automatic component placement machines 150-1 150-2, 150-3. Therefore, the component supports 120-R which have been provided with some of or all their components cannot be transported continuously in the opposite transporting direction GT over the transport runs 140-2 and 140-3 in the area of the automatic component placement machines 150-1, 150-2, 150-3. Consequently, the buffer-storage of component supports 120-R which have been provided with all or some of their components and/or partly or completely soldered is necessary in the portion 140-4 of the transport run 140. If the transport runs 140-2 and 140-3 of the automatic component placement machines 150-1, 150-2 and 150-3 can be passed right through in the opposite transporting direction GT, i.e. at a point in time no component supports 110 not yet provided with all their components are being transported in the main transporting direction HT on the transport runs 140-2 and 140-3 of the automatic component placement machines 150-1, 150-2 and 150-3, the buffer-stored component supports 120-R can be transported over the transport runs 140-2 and 140-3 in the opposite transporting direction GT. The transport runs 140-2 and 140-3 are respectively connected to one another by means of transfer devices 200-1, 200-2, 200-3 and 200-4. Therefore, the transport in the opposite transporting direction GT of the component placement unit on the transport runs 140-2 and 140-3 can be changed at will from the one transport run 140-2 to the other transport run 140-3 and vice versa, since a changeover of the transport runs 140-2 and 140-3 is possible by means of the transfer devices 200-1, 200-2, 200-3 and 200-4 after each subportion of the transport runs 140-2 and 140-3. The transfer devices 200-1, 200-2, 200-3 and 200-4 may have additional buffer stores, which increase the efficiency of the component placement unit still further.

A schematic perspective view of the transfer device 200-3 according to a preferred embodiment of the invention can be seen from FIG. 2. At a number of points, the transfer device 200-3 is facing transport runs 130-1, 130-2, 140-2 and 140-3 of the component placement unit and can, for example by means of one or more transport subruns 210 formed in the manner of conveyor belts, accept the component supports 110, 120 and 120-R transported by the latter or deliver component supports 110, 120 and 120-R to them.

By the transfer device 200-3, transport runs 130-1, 130-2, 140-2 and 140-3 which are in line with one another can be connected to one another by means of the at least one transport subrun 210. In the case of transport runs 130-1, 130-2, 140-2 and 140-3 formed as parallel double or multiple transport runs, the transport subrun 210 of the transfer device 200-3 also runs in parallel at the same distance apart as the transport runs 130-1, 130-2 or 140-2 and 140-3.

The transport subrun 210 is displaceable vertically and/or horizontally, as indicated by the arrows in the vertical and horizontal directions. This allows component supports 110, 120 and 120-R transported on the transport runs 130-1, 130-2, 140-2 and 140-3 to be optionally transferred to one of the transport runs 130-1, 130-2, 140-2 and 140-3. That is to say the component supports 110, 120 or 120-R which are being transported to the transfer device 200-3 either in the main transporting direction HT or in the opposite transporting direction GT can be transferred from that transport run 130-1, 130-2, 140-2 and 140-3 on which they are transported to it onto any other of the transport runs 130-1, 130-2, 140-2 and 140-3 and continue to be transported on the latter.

According to a further refinement of the invention, the transfer unit 200-3 may be additionally provided with a buffer store 250. The buffer store 250 has additional transport subruns 260 which, as shown in the figure, are displaceable in the horizontal direction with respect to the transport runs 130-1, 130-2, 140-2 and 140-3. The alternatively also be vertically displaceable. This allows component supports 110, 120 or 120-R from the transport runs 130-1, 130-2, 140-2 and 140-3 to be stored onto the additional transport subruns 260 of the buffer store 250 and subsequently displaced out of the transporting path together with the additional transport subruns 260, the transport subruns 210 of the transfer unit 200-3 being displaceable into the transporting path of the transport runs 130-1, 130-2, 140-2 and 140-3, so that a connection between in-line transport runs is possible.

If need be, the transport subruns 210 in the transporting path of the transport runs 130-1, 130-2, 140-2 and 140-3 can be changed over once again for the transport subruns 260 and the stored component supports 110, 120 or 120-R are brought out of the buffer store 250 into the transporting path of the transport runs.

A perspective schematic view and a schematic functional view of a portion of a component placement unit which has four automatic component placement machines 150-1, 150-2, 150-3 and 150-4 and five transfer devices 200-1, 200-2, 200-3, 200-4 and 200-5 can be seen in FIGS. 3 and 4. The component placement unit is provided in the area of the automatic component placement machines 150-1, 150-2, 150-3 and 150-4 with two parallel transport runs 140-2 and 140-3. Seen in the main transporting direction HT, a transport run 140-1 and 140-4 can be respectively seen at the beginning and end of the portion of the component placement unit. By means of the transport runs 140-1 and 140-4, component supports 110, 120 and 120-R are transported from or to other processing locations of the component placement unit. Arranged at the beginning and end of each automatic component placement machine 150-1, 150-2, 150-3 and 150-4 in the main transporting direction HT is a transfer device 200-1, 200-2, 200-3, 200-4 and 200-5, respectively.

By means of the transfer devices 200-1, 200-2, 200-3, 200-4 and 200-5, a transfer of component supports 110, 120 and 120-R is possible between the parallel transport runs 140-2 and 140-3 at the beginning and end of each automatic component placement machine 150-1, 150-2, 150-3 and 150-4. In the parallel operation of the automatic component placement machines 150-1, 150-2, 150-3 and 150-4, at the two middle automatic component placement machines 150-2 and 150-3 there must in each case be a transport run 140-2 or 140-3 available for the further transport of component supports 120 already provided with components and a transport run 140-3 or 140-2 for the transport of component supports 110 to be provided with components.

At the first automatic component placement machine 150-1, seen in the main transporting direction HT, a transport run 140-2 or 140-3 is used for feeding component supports 110 which have not been provided with components. The other transport run 140-3 or 140-2 can be used exclusively for the transport of component supports 120-R already provided with components in the opposite transporting direction GT.

At the last automatic component placement machine 150-4, seen in the main transporting direction HT, one of the transport runs 140-2 or 140-3 must be available for the transport of component supports 120 which have already been provided with components in the main transporting direction HT. The other of the transport runs 140-3 or 140-2 can be used exclusively for the transport in the opposite transporting direction GT.

At the two middle automatic component placement machines 150-2 and 150-3, continuous use of one of the transport runs 140-2 and 140-3 in the opposite transporting direction GT is not possible without hindering the supply to the automatic component placement machines 150-3 or 150-4 following in the main transporting direction HT. For further improvement, buffer stores 250 in which the component supports 120-R to be transported in the opposite transporting direction GT can be buffer-stored may therefore be provided at the three middle transfer devices 200-2, 200-3 and 200-4.

If the transport runs of the middle automatic component placement machines 150-2 and 150-3 are not being used for transporting component supports 120 already provided with components or for feeding component supports 110 not provided with components in the main transporting direction HT, because all the component placement locations of the automatic component placement machines 150-3 and 150-4 are already occupied, each of the transport runs 140-2 and 140-3 that are free at the automatic component placement machines 150-2 and 150-3 can be used for the transport of component supports 120-R to be transported in the opposite transporting direction GT. Consequently, effective operation of the component placement unit according to the preferred embodiment of the invention is possible without the processing at the processing locations being disrupted by the transport in the opposite transporting direction GT.

1. A method for the operation of a unit for placing electrical components on component supports (110, 120, 120-R), the unit having a plurality of processing locations (150, 160, 180, 170, 190), which are connected by means of one or more transport runs (130, 140), by means of which the component supports (110, 120, 120-R) are transported in a main transporting direction (HT), with the following steps:
transporting of component supports (110, 120) over the transport run (130, 140) to the processing locations (150, 160, 180, 170, 190) in the main transporting direction (HT),
processing the component supports (110, 120) and/or the electrical components at the processing locations (150, 160, 180, 170, 190),
reversal, at least for a certain time, of the main transporting direction (HT) of one or more of the transport runs (130, 140), with the component supports (120-R) being transported from one processing location (150, 160, 180, 170, 190) to another processing location (150, 160, 180, 170, 190) in the opposite transporting direction (GT).

2. The method as claimed in claim 1, component supports (120-R) provided with some of their components are transported in the opposite transporting direction (GT).

3. The method as claimed in claim 1 or 2, the component supports (120-R) being transported to the processing locations (150, 160, 180, 170, 190) once again in the main transporting direction (HT) after the transporting in the opposite transporting direction (GT).

4. The process as claimed in claims 1 to 3, it being checked before the reversal of the main transporting direction (HT) whether the transport run (130, 140) is free for the transport in the opposite transporting direction (GT).

5. The method as claimed in claims 1 to 4, the component supports (120-R) being buffer-stored before the transporting in the opposite transporting direction (GT).

6. The method as claimed in claim 5, the component supports (120-R) being transported individually in the opposite transporting direction (GT) after the buffer-storage.

7. A unit for carrying out the method as claimed in one of claims 1 to 6, with a plurality of processing locations (150, 160, 180, 170, 190) and one or more transport runs (130, 140), characterized in that
the main transporting direction (HT) of the transport runs (130, 140) can be selectively reversed for transport operations from one processing location (150, 160, 180, 170, 190) to another processing location (150, 160, 180, 170, 190).

8. The unit as claimed in claim 7, characterized in that a control unit coupled to the transport runs (130, 140) and/or to the processing locations (150, 160, 180, 170, 190) is provided, from which unit it can be checked on the basis of determined information concerning the state of the transport runs (130, 140) whether the reversal of the main transporting direction (HT) can be carried out without impairment of the processing by the processing locations (150, 160, 170, 180, 190).

9. The unit as claimed in claim 7 or 8, two or more transport runs (130, 140) and one or more transfer devices (200) being provided, by which component supports (110, 120, 120-R) can be transported between the transport runs (130, 140), characterized in that
the main transporting direction (HT) of the transfer devices (200) is selectively reversible.

10. The unit as claimed in claim 9, at least one transport run (130) running through the processing locations (150, 160, 180, 170, 190) and the transfer devices (200) being arranged upstream and/or downstream of the processing locations (150, 160, 180, 170, 190).

11. The unit as claimed in claim 9 or 10, the transfer devices (200) having buffer stores (250), in which processed, partly processed and/or unprocessed component supports (110, 120, 120-R) can be stored.

12. A transfer device (200) for a component placement unit with at least two transport runs (130, 140) for component supports (110, 120, 120-R) and a plurality of processing locations (150, 160, 180, 170, 190) connected by means of the transport runs (130, 140) for the processing of component supports and/or electrical components, the transfer device (200) having at least one transport subrun (210), which can be displaced vertically and/or horizontally and is at least temporarily in line with the transport runs (130, 140), characterized in that
the main transporting direction (HT) of the transport subruns (210) of the transfer device (200) is selectively reversible.

13. The transfer device as claimed in claim 12, characterized in that
the transfer device (200) has a buffer store (250), in which component supports (110, 120, 120-R) provided with some of or all their components can be stored.

14. The transfer device as claimed in claim 13, characterized in that
the buffer store (250) is formed as a horizontally and/or vertically displaceable transport subrun (260), which for storing or delivering component supports (110, 120, 120-R) is at least temporarily in line with the transport runs (130, 140).

15. The transfer device as claimed in claims 12 to 14 for a component placement unit, in which the transport runs (130, 140) are in each case formed as a plurality of parallel transport runs (130, 140) with a fixed distance from one another, characterized in that
the transport subruns (210, 260) are formed as a number, corresponding to the plurality, of parallel transport subruns (210, 260) which are at the fixed distance from one another, and the parallel transport subruns (210, 260) are held on a common support which can be displaced horizontally and/or vertically
in relation to the transport runs (130, 140).
